(19) United States
(12) Patent Application Publication
(10) Pub. No.: US 2026/0104696 A1
(43) Pub. Date: Apr. 16, 2026

(54) OPTIMIZATION OF FABRICATION PROCESSES

(71) Applicant: Lam Research Corporation, Fremont, CA (US)

(72) Inventors: Yu Lu, Palo Alto, CA (US); Sae Na Park, San Jose, CA (US); Kah Jun Hong, Singapore (SG); Lucas Ryan Frey, San Lorenzo, CA (US); Zachary Jake Blum, New York, NY (US); Niklas Roschewsky, Lake Oswego, OR (US); ArulMurugan Ambikapathi, Singapore (SG); Chao Liu, Singapore (SG); Mehmet Derya Tetiker, Santa Clara, CA (US)

(21) Appl. No.: 19/116,586

(22) PCT Filed: Sep. 28, 2023
(86) PCT No.: PCT/US2023/033955

§ 371 Date: Mar. 28, 2025

Related U.S. Application Data
(60) Provisional application No. 63/377,840, filed on Sep. 30, 2022.

(51) Int. Cl. G05B 19/418

(52) U.S. Cl. CPC G05B 19/41885; G05B 2219/23005; G05B 2219/2602

(57) ABSTRACT

Methods, systems, and media for optimization of fabrication processes are provided. In some implementations, a method of automatically optimizing fabrication processes comprises: (a) providing a first set of process parameter values associated with a first experiment to a model representing a fabrication process; (b) characterizing a statistical uncertainty of predictions made by the model; (c) using an acquisition function to select a second set of process parameter values, wherein the acquisition function identifies the second set of process parameters based on both: (i) a difference between predicted wafer characteristics and a target specification; and (ii) the statistical uncertainty; (d) receiving results of the fabrication process performed using the second set of process parameter values; and (e) determining whether the performance of the fabrication process generates a post-processed wafer having wafer characteristics that meet the target specification.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in its entirety.

### BACKGROUND

Process development, e.g., identifying process parameter values to be used in a given fabrication process to achieve target wafer specifications, can be a time-consuming and resource-consuming process. For example, many iterations of trial and error, manually guided by process engineers, may be needed to identify process parameter values to achieve target specifications.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Systems, apparatuses, methods, and media for optimization of fabrication processes are provided.

In some implementations, a method of automatically optimizing fabrication processes comprises: (a) providing a first set of process parameter values associated with a first experiment to one or more models representing a fabrication process to obtain model results that associate a set of candidate process parameter values with corresponding wafer characteristic data, wherein the fabrication process is an etch process or a deposition process; (b) characterizing a statistical uncertainty of predictions made by the one or more models representing the fabrication process using the obtained model results; (c) using an acquisition function to select a second set of process parameter values associated with a second experiment, wherein the acquisition function identifies the second set of process parameters based on both: (i) a difference between predicted wafer characteristics associated with performance of the fabrication process using the second set of process parameter values and a target specification, wherein the predicted wafer characteristics are generated by the one or more models representing the fabrication process using the second set of process parameter values; and (ii) the statistical uncertainty of the predictions made by the one or more models; (d) receiving results of the fabrication process performed using the second set of process parameter values associated with the second experiment; and (e) determining whether the performance of the fabrication process using the second set of process parameter values generates a post-processed wafer having one or more wafer characteristics that meet the target specification based on the received results of the fabrication process.

In some examples, the method further comprises repeating (b)-(e) until a post-processed wafer that meets the target specification has been generated using the fabrication process.

In some examples, the target specification is a user-specified target specification.

In some examples, the acquisition function is a user-selected acquisition function. In some examples, the acquisition function is configured to probabilistically quantify the improvement an arbitrary set of process parameter values would make in approaching the target specification compared to a baseline experiment.

In some examples, the method further comprises receiving user-selected hyperparameters that specify a balance between exploration and exploitation utilized by the acquisition function to select the second set of process parameter values.

In some examples, the target specifications comprise a plurality of specifications to be achieved in a post-processed wafer that undergoes the fabrication process.

In some examples, the one or more models representing the fabrication process comprise at least one user-selected model.

In some examples, the one or more models representing the fabrication process comprise a physics-based model.

In some examples, the one or more models representing the fabrication process comprises one or more of: a neural network, a Gaussian Process model, decision tree model, regression model, or any combination thereof.

In some examples, characterizing the statistical uncertainty of the predictions made by the one or more models comprises determining a predictive posterior distribution that indicates a probability distribution of predicted wafer characteristics for a given set of process parameter values based on a set of measured data provided to the one or more models. In some examples, for an n-dimensional representation of process parameter space, a first region of the n-dimensional representation of the process parameter space is associated with greater statistical uncertainty than a second region of the n-dimensional representation of the process parameter space, and wherein the one or more models have received less experimental data obtained utilizing process parameter values associated with the first region. In some examples, the second region of the n-dimensional representation of the process parameter space is associated with process parameter values that, when utilized by the fabrication process, generate post-processed wafers having wafer characteristics within a predetermined threshold of the target specification. In some examples, the acquisition function is configured to determine whether to select the second set of process parameter values from either the first region or the second region. In some examples, the n-dimensional representation of process parameter space is substantially unbounded for at least one dimension.

According to some embodiments, a method of automatically optimizing fabrication processes is provided. The method may comprise: (a) receiving a plurality of target wafer specifications to be achieved by a fabrication process; (b) providing a first set of process parameters associated with a first experiment to one or more models representing the fabrication process to obtain model results that associate a set of candidate process parameter values with corresponding wafer characteristics data; (c) characterizing a statistical uncertainty of predictions made by the one or more models representing the fabrication process using the obtained model results; and (d) using an acquisition function to select a second set of process parameter values associated with a second experiment, wherein the acquisition function identifies the second set of process parameter values based on: (i) a set of points that represents differences between a plurality of predicted wafer characteristics associated with performance of the fabrication process using the second set of process parameter values and the plurality of target wafer specifications; and (ii) the statistical uncertainty of the predictions made by the one or more models.

In some examples, the set of points improve on-wafer performance with respect to the plurality of target wafer specifications.

In some examples, the set of points comprise a Pareto Front. In some examples, the acquisition function determines an expected improvement in a hypervolume formed by the Pareto Front using the plurality of predicted wafer characteristics associated with the performance of the fabrication process using the second set of process parameter values.

In some examples, at least two process parameter values in the second set of process parameter values different from the corresponding process parameter values in the first set of process parameter values.

In some examples, the method further comprises determining, based at least in part on the set of points, that at least target wafer specification of the plurality of target wafer specifications cannot be met by the fabrication process. In some examples, the method further comprises identifying a second plurality of predicted wafer characteristics within a predetermined error threshold of the plurality of target wafer specifications, wherein the second plurality of predicted wafer characteristics is associated with performance of the fabrication process using a third set of process parameter values.

In some implementations, computer program product comprising a non-transitory computer readable medium on which is provided computer executable instructions for causing a computational system to perform a method of automatically optimizing fabrication processes is provided. The method may comprise: (a) providing a first set of process parameter values associated with a first experiment to one or more models representing a fabrication process to obtain model results that associate a set of candidate process parameter values with corresponding wafer characteristic data, wherein the fabrication process is an etch process or a deposition process; (b) characterizing a statistical uncertainty of predictions made by the one or more models representing the fabrication process using the obtained model results; (c) using an acquisition function to select a second set of process parameter values associated with a second experiment, wherein the acquisition function identifies the second set of process parameters based on both: (i) a difference between predicted wafer characteristics associated with performance of the fabrication process using the second set of process parameter values and a target specification, wherein the predicted wafer characteristics are generated by the one or more models representing the fabrication process using the second set of process parameter values; and (ii) the statistical uncertainty of the predictions made by the one or more models; (d) receiving results of the fabrication process performed using the second set of process parameter values associated with the second experiment; and (e) determining whether the performance of the fabrication process using the second set of process parameter values generates a post-processed wafer having one or more wafer characteristics that meet the target specification based on the received results of the fabrication process.

In some examples, the method further comprises repeating (b)-(e) until a post-processed wafer that meets the target specification has been generated using the fabrication process.

In some examples, the target specification is a user-specified target specification.

In some examples, the acquisition function is a user-selected acquisition function. In some examples, the acquisition function is configured to probabilistically quantify the improvement an arbitrary set of process parameter values would make in approaching the target specification compared to a baseline experiment.

In some examples, the method further comprises receiving user-selected hyperparameters that specify a balance between exploration and exploitation utilized by the acquisition function to select the second set of process parameter values.

In some examples, the target specifications comprise a plurality of specifications to be achieved in a post-processed wafer that undergoes the fabrication process.

In some examples, the one or more models representing the fabrication process comprise at least one user-selected model.

In some examples, the one or more models representing the fabrication process comprise a physics-based model.

In some examples, the one or more models representing the fabrication process comprises one or more of a neural network, a Gaussian Process model, decision tree model, regression model, or any combination thereof.

In some examples, characterizing the statistical uncertainty of the predictions made by the one or more models comprises determining a predictive posterior distribution that indicates a probability distribution of predicted wafer characteristics for a given set of process parameter values based on a set of measured data provided to the one or more models. In some examples, for an n-dimensional representation of process parameter space, a first region of the n-dimensional representation of the process parameter space is associated with greater statistical uncertainty than a second region of the n-dimensional representation of the process parameter space, and wherein the one or more models have received less experimental data obtained utilizing process parameter values associated with the first region. In some examples, the second region of the n-dimensional representation of the process parameter space is associated with process parameter values that, when utilized by the fabrication process, generate post-processed wafers having wafer characteristics within a predetermined threshold of the target specification. In some examples, the acquisition function is configured to determine whether to select the second set of process parameter values from either the first region or the second region. In some examples, the n-dimensional representation of process parameter space is substantially unbounded for at least one dimension.

According to some embodiments, a computer program product comprising a non-transitory computer readable medium on which is provided computer executable instructions for causing a computational system to perform a method of automatically optimizing fabrication processes is provided. The method may comprise: (a) receiving a plurality of target wafer specifications to be achieved by a fabrication process: (b) providing a first set of process parameters associated with a first experiment to one or more models representing the fabrication process to obtain model results that associate a set of candidate process parameter values with corresponding wafer characteristics data: (c) characterizing a statistical uncertainty of predictions made by the one or more models representing the fabrication process using the obtained model results; and (d) using an acquisition function to select a second set of process parameter values associated with a second experiment, wherein the acquisition function identifies the second set of process parameter values based on: (i) a set of points that represents differences between a plurality of predicted wafer characteristics associated with performance of the fabrication process using the second set of process parameter values and the plurality of target wafer specifications; and (ii) the statistical uncertainty of the predictions made by the one or more models.

In some examples, the set of points improve on-wafer performance with respect to the plurality of target wafer specifications.

In some examples, the set of points comprise a Pareto Front. In some examples, the acquisition function determines an expected improvement in a hypervolume formed by the Pareto Front using the plurality of predicted wafer characteristics associated with the performance of the fabrication process using the second set of process parameter values.

In some examples, at least two process parameter values in the second set of process parameter values different from the corresponding process parameter values in the first set of process parameter values.

In some examples, the method further comprises determining, based at least in part on the set of points, that at least target wafer specification of the plurality of target wafer specifications cannot be met by the fabrication process. In some examples, the method further comprises identifying a second plurality of predicted wafer characteristics within a predetermined error threshold of the plurality of target wafer specifications, wherein the second plurality of predicted wafer characteristics is associated with performance of the fabrication process using a third set of process parameter values.

### BRIEF DESCRIPTION OF THE DRAWINGS

FIG. 1 depicts an example system for optimization of fabrication processes in accordance with some embodiments.

FIG. 2 is a flowchart of an example process for optimization of fabrication processes in accordance with some embodiments.

FIGS. 3A-3D are graphs that indicate the evolution of selected process parameters over several iterations of an optimization process in accordance with some embodiments.

FIG. 4 is a flowchart of an example process for optimization of fabrication processes for an etch process and/or a deposition process in accordance with some embodiments.

FIG. 5 is a flowchart of an example process for optimization of fabrication processes to achieve multiple target specifications in accordance with some embodiments.

FIG. 6 presents an example computer system that may be employed to implement certain embodiments described herein.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

In process development, a process engineer may typically need to identify process parameter values for a given fabrication process to achieve a target (e.g., customer-specified) specification or set of target specifications. Conventionally, this process may be time and labor intensive. For example, typically, the process engineer may have to perform several experiments to identify the optimal process parameter values to meet the specifications. Because there may be many process parameters (e.g., temperature parameters, gas flow pressure parameters, gas species parameters, gas flow rate parameters, etc.), this process may require several (e.g., tens, hundreds, thousands, etc.) iterations of trial and error, particularly when there are multiple specifications to be met. For example, a change in one process parameter value may have one effect (e.g., a beneficial effect) on a first target specification, and a different (e.g., a negative effect) on a second target specification. Accordingly, because multiple process parameters may be adjusted, each having a different effect on each target specification, manual process development is costly in time and resources.

Disclosed herein are techniques for optimized process development. In particular, the techniques described herein utilize machine learning algorithms and statistical (e.g., Bayesian) inference to guide process development. A process model (sometimes referred to herein as “a surrogate model”) may be used to model or simulate a given fabrication process (e.g., an etch process, a deposition process, etc.). Because there may not be enough experimental data (e.g., obtained via prior fabrication processes) to constrain the process model, there may be statistical model uncertainty that underlies the predictions of the process model. The model uncertainty may be due to a lack of training data. The techniques disclosed herein use statistical inference techniques to optimally select a set of process parameter values to be used in a next experiment. The optimally selected set of process parameter values are selected based on an acquisition function which quantitatively accounts for the modeling epistemic uncertainty and balances tradeoffs between improving upon the current best set of wafer characteristics toward the target specification(s), further constraining the statistical uncertainty associated with the underlying process model (e.g., surrogate model). By iteratively selecting next process parameter values to try in subsequent experiments, an optimal set of process parameter values may be efficiently identified, even in instances where there are multiple competing target specifications and/or in instances in which there are many process parameters that may be adjusted.

Moreover, as described below in more detail, the acquisition function may allow an essentially unbounded process parameter space to be explored. In this way, process parameter values that differ substantially from previously tried process parameter values may be tried in some experiments (e.g., based on a likelihood that these values will improve the current best processed wafer characteristics toward the target specification(s)). The acquisition function may efficiently balance exploration of previously untested regions of the parameter space versus exploitation of known regions of the parameter space that is likely to improve the on-wafer performance.

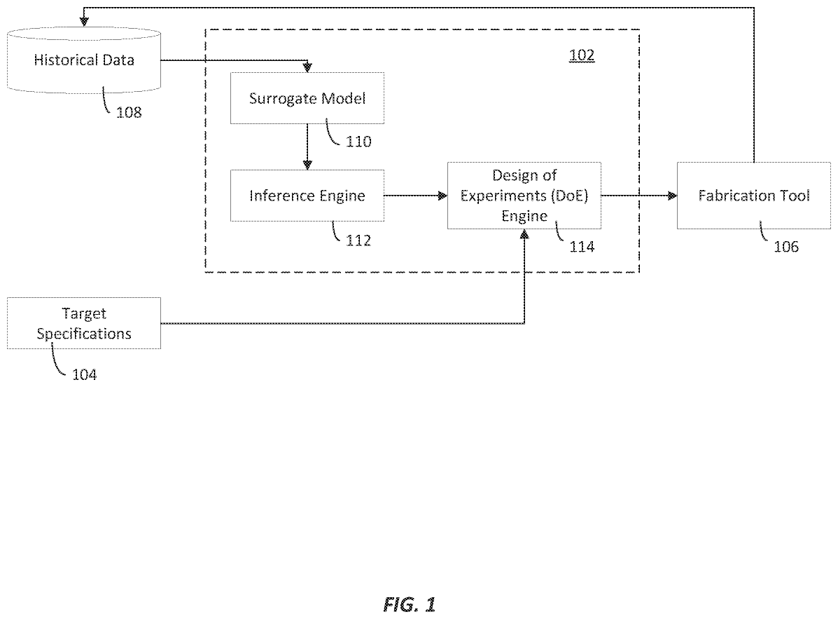

FIG. 1 is an example of a system for optimization of fabrication processes in accordance with some embodiments. As illustrated, optimization system 102 may be configured to iteratively determine experiments to be performed by a fabrication tool 106, where each experiment is selected based on a model of a fabrication process to be performed by fabrication tool 106 and to achieve target specifications 104. In other words, optimization system 102 may identify an experimental set of process parameters to be used in connection with a fabrication process (e.g., an etch process and/or a deposition process) performed by fabrication tool 106, where each iterative set of process parameters identified by optimization system 102 are selected to iteratively approach target specifications 104. In some implementations, target specifications 104 may indicate various specifications for features of a wafer processed using the fabrication process by fabrication tool 106, including but not limited to geometrical measures such as a target etch depth, a target deposition thickness, a target aspect ratio, a target sidewall angle, a target sidewall depth, a target critical dimension, a target pitch, electrical specifications such as resistance and capacitance, etc. In some implementations, target specifications 104 may include one or more (e.g., two, three, five, ten, etc.) target specifications, as will be discussed below in more detail.

In some implementations, optimization system 102 may include a surrogate model 110, an inference engine 112, and a design of experiments (DoE) engine 114. Surrogate model 110 may be one or more models which model a fabrication process to be performed by fabrication tool 106 to meet target specifications 104. Surrogate model 110 may include any suitable type of models, such as a neural network, a Bayesian neural network, a regression model, a Gaussian process model, a physics-based model, a decision tree, and/or any combination thereof. Surrogate model 110 may be configured to consider historical data 108, which may include metrology results of previously processed wafers (e.g., processed by fabrication tool 106) and the corresponding process parameters which yielded processed wafers having the metrology results. In some embodiments, surrogate model 110 may be trained using historical data 108. In some implementations, surrogate model 110 may be more than one model (e.g., two models, three models, ten models, etc.), or an ensemble of multiple models. In some such embodiments, the multiple models may be of the same type (e.g., neural networks, regression models, physics-based models, etc.), or of different types.

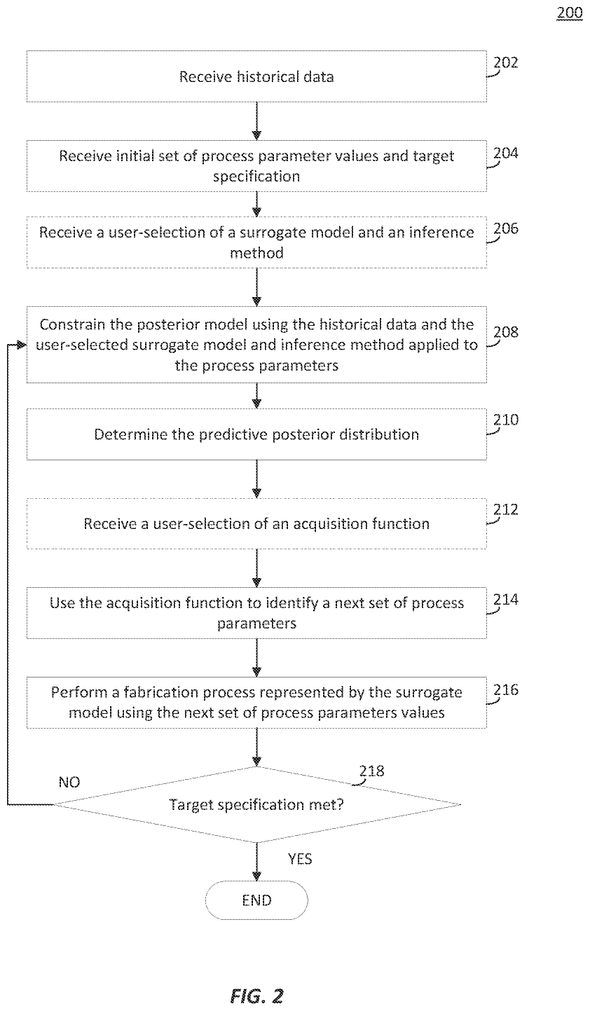

The output of surrogate model 110 may be used by inference engine 112 to constrain the model data. For example, inference engine 112 may generate information indicating a statistical uncertainty of the output of surrogate model 110. As a more particular example, as described below in connection with FIG. 2, inference engine 112 may generate a predicted posterior distribution of data based on the model output generated by surrogate model 110 and/or historical data 108.

DoE engine 114 may utilize the output of inference engine 112 (e.g., the statistical uncertainty information generated by inference engine 112) to generate a next experiment to be performed by fabrication tool 106. In some implementations, the next experiment may specify a set of process parameter values to be utilized in the next experiment. In some embodiments, DoE engine 114 may select the next process parameter values associated with the next experiment to be performed such that the result of the next experiment, when performed as a fabrication process by fabrication tool 106, will yield a post-processed wafer having wafer characteristics that are closer to target specifications 104 than the current optimal process parameters. In other words, DoE engine 114 may iteratively identify experimental process parameter values that iteratively identify process parameters such that post-processed wafer characteristics approach target specifications 104. Additionally or alternatively, in some implementations, the process parameter values associated with the next experiment may be those that serve to further constrain the statistics uncertainty estimate generated by inference engine 112. For example, DoE engine 114 may, in a given iteration, identify a next experiment that, when performed, will reduce statistical uncertainty, even if the experiment does not yield a post-processed wafer having wafer characteristics that are closer to target specifications 104 than the previous experiment yielded. In some implementations, DoE engine 114 may balance tradeoffs between reducing statistics uncertainty and identifying parameter values that yield wafer characteristics within an acceptable margin of the target specifications using hyperparameters that tune explore versus exploit. For example, in some iterations, DoE engineer 114 may prioritize exploration, and may identify next experiments likely to reduce statistical uncertainty. Conversely, in some iterations, DoE engine 114 may prioritize exploitation, and may identify next experiments that are associated with parameter values in a region of low statistical uncertainty that are likely to hone in on the target specifications. In some embodiments, DoE engine 114 may utilize an acquisition function to select process parameters associated with the next experiment. In some implementations, a balance between exploration and exploitation may be tuned using hyperparameters of the acquisition function.

In some embodiments, the techniques described herein may utilize a surrogate model to evaluate a first set of process parameter values. The data generated by the model, in association with historical information (e.g., metrology information collected from previously processed parameters) may be used to constrain the model based on the data. Statistical uncertainty of the model may then be determined, for example, in the form of a predictive posterior distribution. The predictive posterior distribution may indicate the likelihood of a particular set of wafer characteristics being achieved given a set of process parameter values and the underlying data (e.g., generated by the model and/or historical data). Note that the predictive posterior distribution indicates the certainty associated with a given prediction. An acquisition function may then be used to select a next set of process parameter values to evaluate (e.g., in a next experiment). As described above, the acquisition function may effectively balance a tradeoff between exploration and exploitation given the statistical uncertainty associated with the model. For example, the acquisition function may select the next set of process parameter values from a region of relatively high uncertainty in order to further explore the process parameter space. Conversely, in some instances, the acquisition function may select the next set of process parameter values from a region of relatively low uncertainty in order to hone in on process parameter values likely to drive closer to target wafer specifications. Note that, in some implementations, the acquisition function may switch between exploration and exploitation on an iteration-by-iteration basis.

FIG. 2 is a flowchart of an example process 200 for optimization of fabrication processes in accordance with some embodiments. In some implementations, blocks of process 200 may be executed on a server device and/or a controller device of a fabrication tool. In some embodiments, blocks of process 200 may be executed in an order other than what is shown in FIG. 2. In some implementations, two or more blocks of process 200 may be executed substantially in parallel. In some embodiments, one or more blocks of process 200 may be omitted.

Process 200 can begin at block 202 by receiving historical data. In some implementations, the historical data may include metrology results associated with previously processed wafers. The historical data may pertain to a particular fabrication process and/or to a particular fabrication tool or class of fabrication tools. Note that metrology results may include in situ and/or ex situ results. Examples of metrology techniques that may be used to provide the historical data include electron microscopy (EM), transmission electron microscopy (TEM), scanning electron microscopy (SEM), critical dimension SEM (CD-SEM), or the like. In some embodiments, the historical data may include metrology results paired with the process parameter values that yielded the given metrology results, thereby allowing process parameter values to be mapped to the resulting post-processed wafer characteristics.

At 204, process 200 can receive an initial set of process parameter values and a target specification. The target specification may indicate a user-specified (e.g., customer-specified) specification that a post-processed wafer is to meet. The target specification may include one or more wafer feature specifications such as target etch depth, target deposition thickness, target sidewall thickness, target aspect ratio, etc. The initial set of process parameter values may be selected in any suitable manner. For example, in some embodiments, the initial set of process parameter values may be user-specified. As another example, in some embodiments, the initial set of process parameter values may be randomly selected, or randomly selected from within a predetermined range.

At 206, process 200 can receive a user-selection of a surrogate model and an inference method. Examples of types of surrogate models that may be utilized include a regression model, a neural network, a physics-based numerical simulation model, or the like. Example types of inference methods that may be used include variational inference, Markov chain Monte Carlo (MCMC), Local Gaussian Approximation (LGA), or the like. In some embodiments, the surrogate model and the inference method may be combined in one model family, such as a Gaussian process (GP) model, a Tree Parzen Estimulator (TPE) model, or the like. User-selection of the surrogate model and/or the inference method may be via a user interface, via values set in a configurations file, or the like. Note that, in some implementations, the surrogate model and the inference method may be fixed or hard-coded. In such instances, block 206 may be omitted.

At 208, process 200 can constrain the posterior model using the historical data, the surrogate model, and the inference method by applying the initial set of process parameter values to the surrogate model and using the inference method to constrain the output of the surrogate model. The posterior model may represent uncertainties in the surrogate model. In some embodiments, the posterior model may be constrained using the following techniques. Given the initial set of process parameter values and other recipe set points K, model parameters of the surrogate model θ, a predicted set of wafer characteristics W, predicted using the surrogate model with the initial set of process parameter values, may be represented as W̅=M(K, θ). A probability distribution representing the likelihood of various wafer characteristics W given a set of process parameter values K and surrogate model parameters θ, represented herein as p(W|K, θ) may be determined based on the distribution of various wafer characteristics. For example, the probability distribution may be determined by:

$$p ( W \vert K , θ ) = N ( \overline{W ,} {σ}_{W}^{2} )$$

Continuing with this example, the constrained posterior model, represented herein as p(θ, D), where D represents the historical data, may be determined by:

$$p ( θ \vert D ) = \frac{p ( θ ) L ( D \vert θ )}{p ( D )}$$

In the equation given above, L(D|θ) represents a likelihood of a particular set of data D given surrogate model parameters θ. The constrained posterior model p(θ|D) represents the distribution of model parameters based on the historical data D.

At 210, process 200 can determine the predictive posterior distribution, generally represented herein as p(W|K, D). The predictive posterior distribution represents the probability of achieving wafer characteristics W using a fabrication process with process parameter values K given the historical data D. The predictive posterior distribution may be determined based on the probability distribution of wafer characteristics (represented as p(W|K, θ)) given the surrogate model parameters and the process parameter values, and based on the constrained model (represented as p(θ|D)). For example, in some embodiments, the predictive posterior distribution may be determined by:

$$p ( W \vert K , D ) = \int p ( W \vert K , θ ) p ( θ \vert D ) d θ$$

It should be understood that the predictive posterior distribution may incorporate statistical uncertainties in the historical data D as well as statistical uncertainties associated with predictions generated by the surrogate model.

At 212, process 200 can receive a user-selection of an acquisition function. The acquisition function may be a function that uses the statistical uncertainty in the surrogate model predictions (e.g., using the predictive posterior distribution) to select a next set of process parameter values for a next experiment. As described above, the acquisition function may balance tradeoffs between exploration of regions of the process parameter space associated with higher uncertainty and exploitation of regions of the process parameter space associated with lower uncertainty. Examples of acquisition function includes a probability of improvement acquisition function (in which the next set of process parameter values are selected that have the highest probability of improving the wafer characteristics toward the target specification relative to the current best wafer characteristics) and an expected improvement acquisition function (in which a magnitude of improvement of the next set of process parameter values relative to the current best wafer characteristics is considered). In some implementations, the user-selection of the acquisition function may be via a user interface, via a configurations settings file, or the like. Note that, in some implementations, the acquisition function may be hard coded. In such instances, block 212 may be omitted.

At 214, process 200 can use an acquisition function to identify a next set of process parameter values, e.g., to be used in a next experiment. The definition of an acquisition function may include a utility function, which may quantify the improvement of an on-wafer performance W in achieving the desired objective over the current best result W⁺. By way of example, in an instance in which the acquisition function is an expected improvement (EI) acquisition function, the utility function is defined as the increase in the objective function value f(W) over the current best observed process outcome f(W⁺), and may be determined by:

$${U}_{EI} ( W ) = max [ f ( W ) - f ( {W}^{+} ) , 0 ]$$

In some implementations, the acquisition function may determine the next set of process parameter values using the predictive posterior distribution. By way of example, using an expected improvement (EI) acquisition function, the next set of process parameter values K′ may be determined by:

$$EI ( {K}^{′} ) = {\int }_{{W}^{+}}^{∞} {U}_{EI} ( W ) p ( W \vert {K}^{′} ) dW$$

In the equation given above, K′ represents a next set of process parameter values. The process parameter values K′=argmax[EI(K′)] which maximizes the acquisition function, are chosen to be the set of process parameters values to utilize in the next experiment. The next set of process parameter values K′ may be statistically expected to yield the greatest improvement in the on-wafer performance objective. Following similar ideas, other acquisition functions, such as Probability of Improvement, Lower Confidence Bound, etc. can be computed in the system. As indicated in the above equation, in some implementations, the next set of process parameter values may be determined by considering predicted wafer characteristics that are an improvement over the current best predicted wafer characteristics (e.g., relative to the target specification) and determine the process parameter values likely to maximize improvement of the predicted wafer characteristics using the predictive posterior distribution, which indicates statistical uncertainty of the underlying surrogate model.

Note that although the examples given above relate to an expected improvement acquisition function, similar equations may be used for other acquisition functions, such as a probability of improvement acquisition function. Additionally, in some embodiments, various hyperparameters, such as those used to control a tradeoff between exploration and exploitation, may be included in the acquisition function. In some embodiments, such hyperparameters may be modified by user input or user-selection.

At 216, process 200 can perform a fabrication process represented by the surrogate model using the next set of process parameter values. For example, in some implementations, process 200 can cause instructions to be transmitted to a controller associated with a fabrication tool, where the instructions indicate the next set of process parameter values. The controller can then cause the fabrication process to be performed on a wafer using the fabrication tool and with the next set of process parameter values. Note that, in some implementations, the historical data may be augmented with data (e.g., metrology data) acquired using the results of the fabrication process.

At 218, process 200 can determine whether the target specification received at block 204 has been met for the wafer processed at block 216 using the next set of process parameter values. If, at 218, process 200 determines that the target specification has been met (“yes” at 218), process 200 can end. Conversely, if, at 218, process 200 determines that the target specification has not been met (“no” at 218), process 200 can loop back to block 208 and can further constrain the posterior model using metrology data associated with the wafer processed at block 216.

In some embodiments, process 200 can loop through blocks 208-218 until the target specification is processed. By performing each fabrication process using a set of process parameter values selected using the acquisition function (which is in turn based on the statistical uncertainty of the underlying surrogate model), the target specification may be met with fewer iterations than if each set of process parameter values is manually selected by, e.g., a process engineer. In particular, the acquisition function may be able to quickly hone in on a promising region of the parameter space and then, within the promising region, identify an optimized set of process parameter values by controlling the tradeoffs between exploration and exploitation with respect to the inherent uncertainty of the surrogate model and uncertainties in experimental data. This may in turn allow for more efficient use of fabrication resources by utilizing fewer test wafers to identify the optimal process parameter values.

As described above in connection with FIGS. 1 and 2, experimental process parameter values may be selected, where each set of process parameter values for a given iteration are selected based on predictions by a surrogate model and based on statistical uncertainty associated with the predictions of the surrogate model. As described above, a next set of process parameter values may be selected based on an acquisition function, which considers the uncertainty associated with the predictions of the surrogate model. Over a series of iterations, the process parameter values may evolve such that a wafer processed using the process parameter values achieves (or approaches) target specifications.

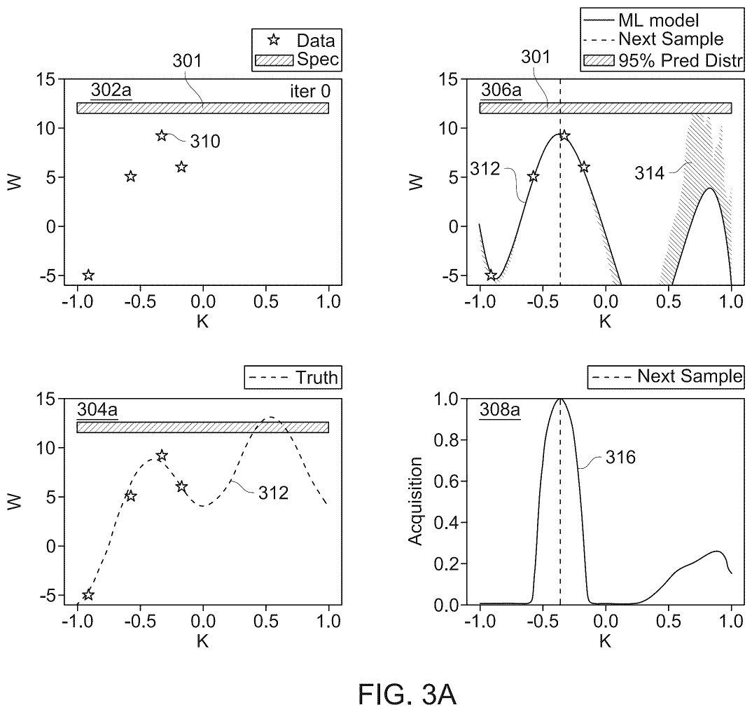

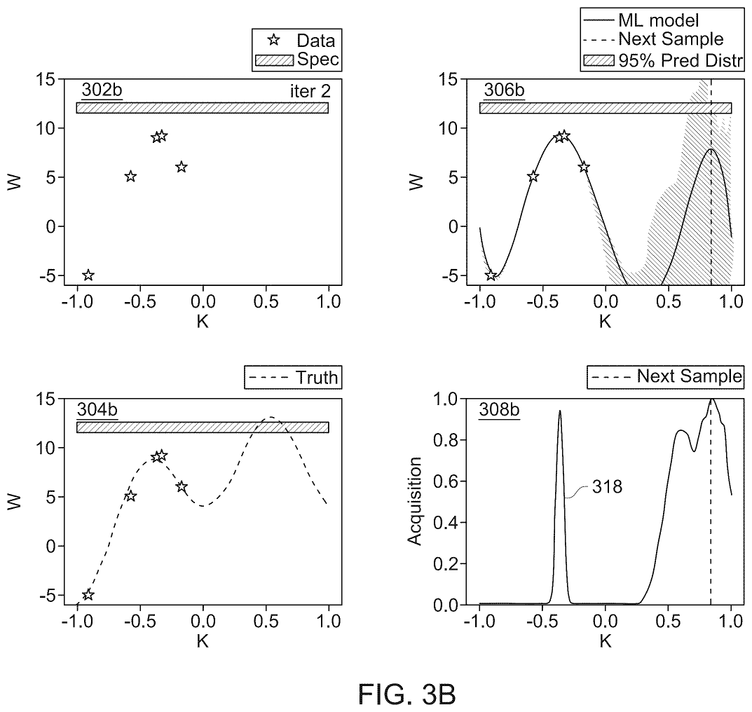

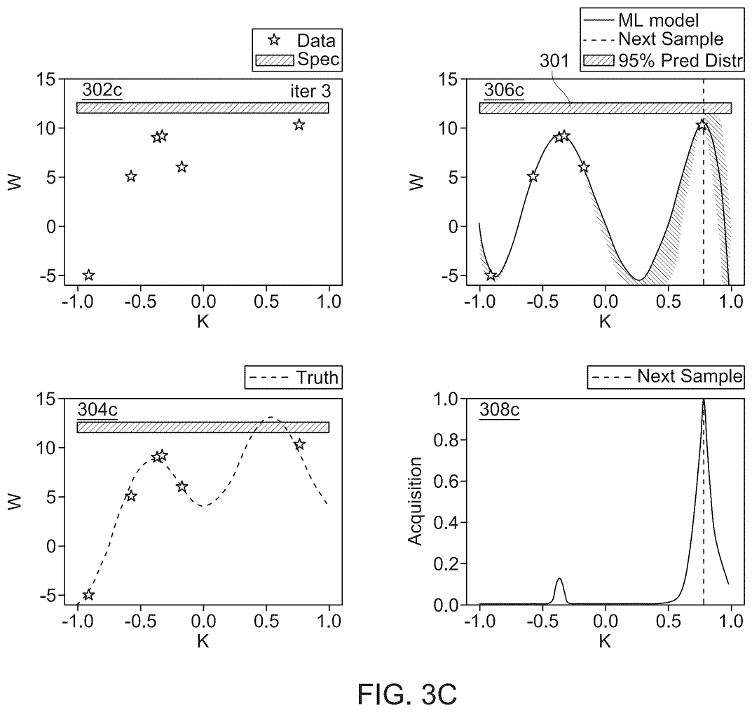

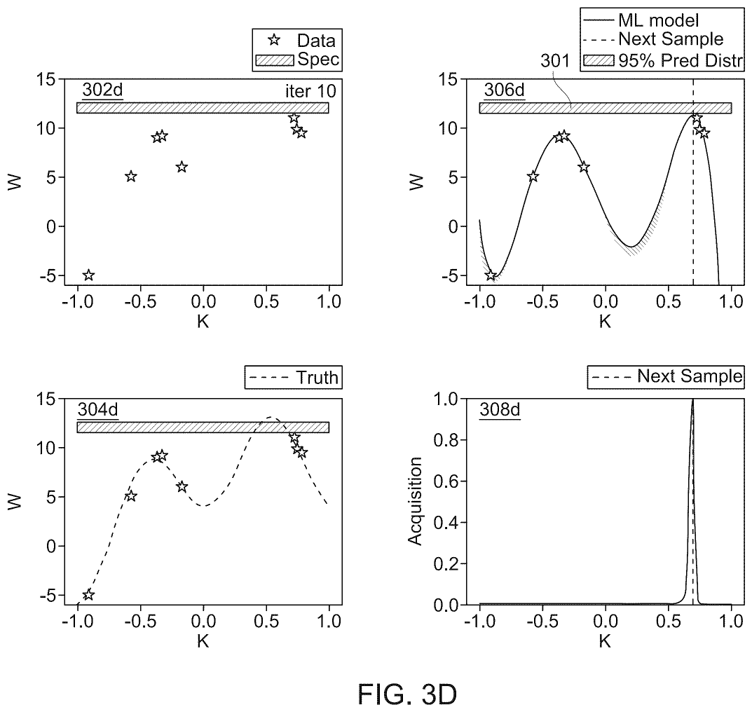

FIGS. 3A-3D illustrate the evolution of process parameter values over a series of iterations in accordance with some embodiments. Referring to panel 302a of FIG. 3A, at iteration 0, an initial set of data (e.g., including data point 310) is utilized by a surrogate model. Referring to panel 304a, the surrogate model generates a prediction 312 to fit the data. The target specification is represented by line 301. Referring to panel 306a, prediction 312 of the surrogate model is associated with an uncertainty 314. Uncertainty 314 represents the statistical uncertainty associated with prediction 312. In some embodiments, uncertainty 314 may be represented by the predictive posterior distribution, as described above in connection with FIG. 2. Note that the data, including data point 310, is clustered in a region of the parameter space K between −1 and 1. Accordingly, there is relatively less uncertainty in the region of the parameter space K in which the data points are clustered, and relatively higher uncertainty in the region of parameter space K in which data has not yet been collected. Referring to panel 308a, an acquisition function 316 is shown which is a function of the parameter space K. Note that the highest value of the acquisition function is about −0.4, which is close to the parameter values (in K-space) that yields the current best wafer characteristic data (e.g., associated with data point 310).

Turning to FIG. 3B, similar plots are shown for iteration 2. Note that more data points have been added as shown in panels 302b, 306b, and 304b, e.g., from experimental results acquired from iteration 0 and iteration 1. Note that acquisition function 318 shown in panel 308b at iteration 2 has two primary peaks—a first peak centered in K-space in the region in which data has been collected, and a second peak centered in K-space in a region in which data has not yet been collected, and therefore, for which there is relatively more uncertainty in the surrogate model predictions. Based on the maximum of acquisition function 318, a next set of process parameter values in K-space are selected for iteration 3.

Turning to FIG. 3C, similar panels 302c. 304c. 306c, and 308c are illustrated. Note that, in iteration 3, due to the acquisition function after iteration 2 indicating that the next set of process parameter values should be in an as of yet unexplored region of K-space (e.g., with K greater than 0.5), the process parameter values evaluated in iteration 3 are from this unexplored region of K-space. As illustrated in panel 306c, the process parameter values tested in iteration 3 substantially reduce the uncertainty associated with the underlying surrogate model. Furthermore, the process parameter values from iteration 3 yield wafer characteristics closer to the target specification 301 relative to the process parameter values utilized in iterations 0-2.

Turning to FIG. 3D, similar panels 302d, 304d, 306d, and 308d are shown for iteration 10. Note that, after ten iterations, uncertainty associated with the surrogate model has been greatly reduced in all regions of K-space, as shown in panel 306d. Moreover, note that process parameter values K have been identified that meet the target specification 301.

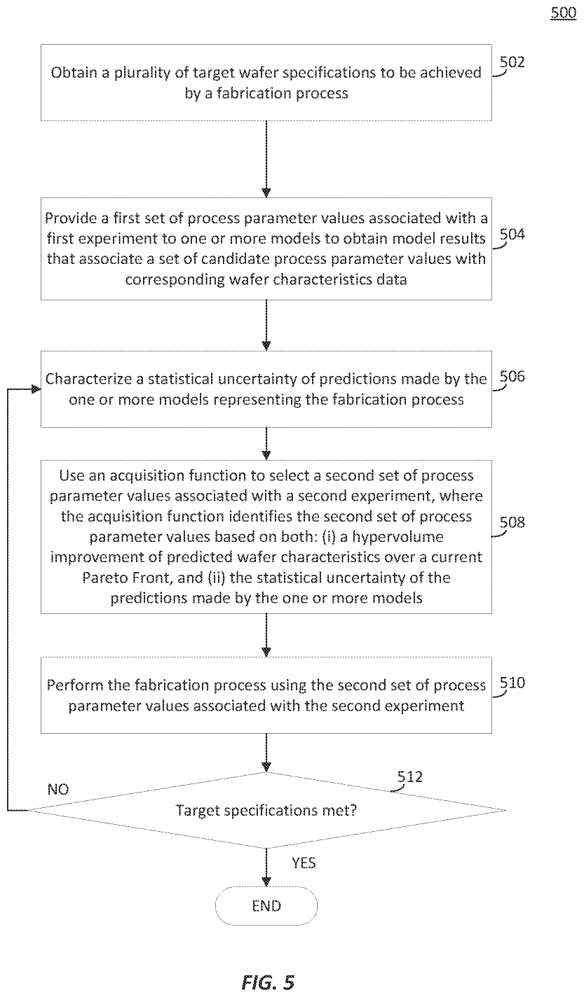

It should be noted that, as illustrated in FIGS. 3A-3D, there are essentially no bounds to the parameter space from which the acquisition function may select next process parameter values for a next experiment. In other words, even in situations in which all available historical data is clustered in a particular region of K-space, the acquisition function may select process parameter values that are outside of this region of K-space based on process parameter values that may reduce statistical uncertainty and/or may lead to wafer characteristics that are closer to the target specification. Moreover, it should be understood that although FIGS. 3A-3D represent the target specification as a line (e.g., a single specification to be met), this is merely an illustration. The techniques may be applied to a set of target specifications (e.g., multiple target specifications), as described below in connection with FIG. 5.

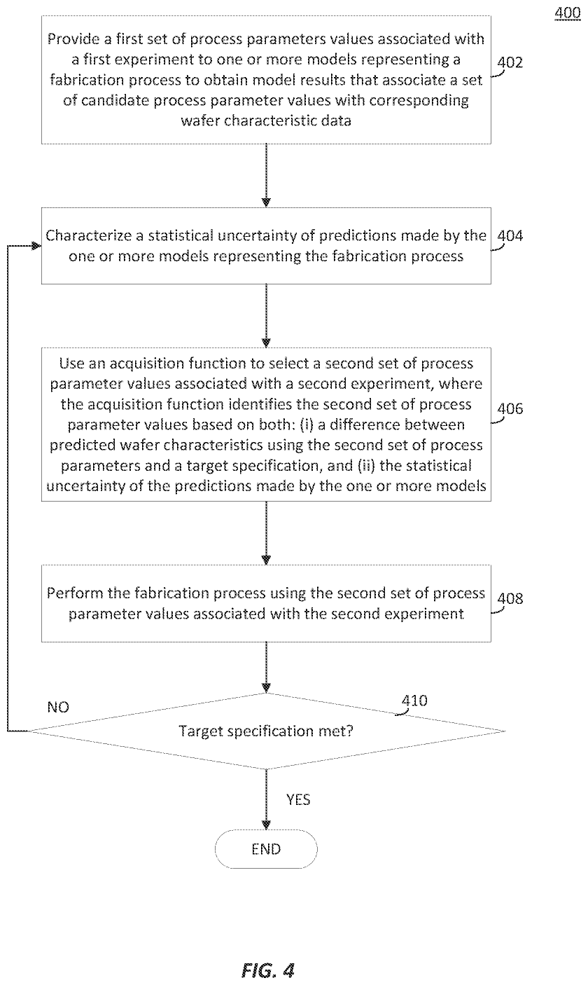

FIG. 4 is a flowchart of an example process 400 for iteratively identifying process parameter values to achieve a target specification in accordance with some embodiments. In some implementations, blocks of process 400 may be performed on a server device and/or on a controller device associated with a fabrication tool. In some embodiments, blocks of process 400 may be performed in an order other than what is shown in FIG. 4. In some embodiments, two or more blocks of process 400 may be performed substantially in parallel. In some embodiments, one or more blocks of process 400 may be omitted.

Process 400 can begin at 402 by providing a first set of process parameter values associated with a first experiment to one or more models representing a fabrication process to obtain model results that associate a set of candidate process parameter values with corresponding wafer characteristic data. As described above in connection with FIGS. 1-3, the one or more models may be one or more surrogate models that represent the fabrication process. In some embodiments, the fabrication process may be an etch process, a deposition process, or the like. The one or more models may be associated with a common model family, such as a neural network, a regression model, a physics-based model, a decision tree, a Gaussian process model, etc. The first set of process parameter values may be identified based on historical data (e.g., based on previous fabrication processes), based on manual specification by a process engineer, randomly from within a range of possible values, etc.

At 404, process 400 can characterize a statistical uncertainty of predictions made by the one or more models representing the fabrication process. As described above in connection with FIG. 2, the statistical uncertainty of predictions made by the one or more models may be the predictive posterior distribution. The statistical uncertainty may be determined based at least in part on historical data (e.g., metrology data acquired from previous experiments or previous fabrication process runs). More detailed example techniques for determining the statistical uncertainty are shown in and described above in connection with FIG. 2.

At 406, process 400 can use an acquisition function to select a second set of process parameter values associated with a second experiment, where the acquisition function identifies the second set of process parameter values based on both: (i) a difference between predicted wafer characteristics using the second set of process parameter values and a target specification; and (ii) the statistical uncertainty of the predictions made by the one or more models. In some implementations, the acquisition function may be a probability of improvement acquisition function, or an expected improvement acquisition function, as shown in and described above in connection with FIG. 2. In some implementations, the acquisition function may be user-specified, e.g., via a user interface or a configuration settings file. Note that, by selecting the second set of process parameter values based on both a difference between the current predicted wafer characteristics and the target specification to be met, as well as the statistical uncertainty of the underlying model, the second set of process parameter values may be selected in a manner that balances an improvement toward the target specification as well as exploration of the process parameter space that has not been experimentally tested. More detailed examples of how the acquisition function may be used to balance exploration of untested process parameter space versus exploitation of a previously tested process parameter space are shown in and described above in connection with FIGS. 3A-3D.

At 408, process 400 can perform the fabrication process using the second set of process parameter values associated with the second experiment. For example, in some implementations, a server on which the acquisition function is executed may transmit instructions to a controller device of a fabrication tool, where the instructions indicate the second set of process parameter values to be utilized in the second experiment. The controller may then cause the fabrication tool to perform the second experiment (e.g., the fabrication process using the second set of process parameter values) on a wafer.

At 410, process 400 may determine whether the target specification has been met. In other words, process 400 may determine whether the post-processed wafer from the second experiment has met the target specification.

If, at 410, process 400 determines that the target specification has been met (“yes” at 410), process 400 can end. Conversely, if, at 410, process 400 determines that the target specification has not been met (“no” at 410), process 400 can loop back to 404 and can update the statistical uncertainty of predictions made by the one or more models using, e.g., metrology results associated with the wafer processed at block 408. In some implementations, process 400 can loop through blocks 404-410 until an experiment (e.g., fabrication process) is performed using process parameter values to meet the target specification. In some embodiments, process 400 can end after a predetermined number of iterations regardless of whether the target specification has been met.

In some implementations, the techniques described herein may be utilized to identify process parameter values to be used to meet multiple target wafer specifications rather than a single target specification. In such cases, an acquisition function may identify process parameter values for a next experiment for multiple process parameter values that are likely to achieve wafer characteristics that are closer to the multiple target specifications as a whole. It should be understood that, in some cases, not all target specifications may be met, or may be achievable. However, the techniques described herein may allow process parameter values to be identified that balance tradeoffs between one or more target specifications being met and other target specifications not being met, thereby achieving an optimal solution. In other words, the techniques described herein may identify process parameter values that optimally balance tradeoffs between multiple target specifications. In some cases, in instances in which not all target specifications are met, the optimal solution may involve wafer characteristics for each specification being within a predetermined threshold of the target for the specification. It should be noted that, in some implementations, a set of points that optimally balanced tradeoffs between multiple objectives (e.g., multiple specifications to be met) may be referred to as the Pareto Front. The Pareto Front is a hypersurface that separate the performance space known to be achievable and the performance space not yet known to be achievable. The techniques described herein may iteratively propose a sequential set of experiments that improve the Pareto Front, thereby maximizing the process space in various metrology metrics. Process engineers may be able to use a Pareto Front that has been identified and/or characterized to prioritize metrology specifications (e.g., target metrology specifications) to balance tradeoffs between multiple competing metrology specifications objectives for a given process limitation.

In some embodiments, the techniques described herein may identify the process parameter values to be used to optimally balance tradeoffs between the multiple target specifications by identifying a set of non-dominated points. As used herein, “non-dominated” refers to a point (e.g., a set of process parameter values) that are as good as every other point (e.g., set of process parameter values) in terms of meeting the multiple target specifications and are better than at least one other point (e.g., set of process parameter values) for at least one target specification of the multiple target specifications. In some embodiments, a hypervolume metric H may be determined that characterizes the volume formed by the set of non-dominated points. In some such embodiments, an acquisition function may consider improvement in the hypervolume metric H in order to select a next set of process parameter values. Note that a larger hypervolume value corresponds to a better solution set. By adding experimental points that dominate over points in the current Pareto Front, the hypervolume may be expanded. This expansion may be characterized by the hypervolume improvement, as described below in more detail in connection with FIG. 5.

FIG. 5 is a flowchart of an example process 500 for identifying process parameter values in a manner that balances tradeoffs between multiple target specifications in accordance with some embodiments. In some implementations, blocks of process 500 may be executed by a server device and/or a controller of a fabrication tool. In some embodiments, blocks of process 500 may be executed in an order other than what is shown in FIG. 5. In some implementations, two or more blocks of process 500 may be performed substantially in parallel. In some implementations, one or more blocks of process 500 may be omitted.

Process 500 can begin at 502 by obtaining a plurality of target wafer specifications to be achieved by a fabrication process. The plurality of target wafer specifications may include a target etch depth, a target deposition thickness, a target sidewall angle, a target aspect ratio, etc. The target wafer specifications may be user-specified.

At 504, process 500 can provide a first set of process parameter values associated with a first experiment to one or more models to obtain model results that associate a set of candidate process parameter values with corresponding wafer characteristic data. Block 504 may be performed using techniques similar to those described above in connection with block 402 of FIG. 4.

At 506, process 500 can characterize a statistical uncertainty of predictions made by the one or more models representing the fabrication process. Block 506 may be performed using techniques similar to those described above in connection with block 404 of FIG. 4.

At 508, process 500 can use an acquisition function to select a second set of process parameter values associated with a second experiment. In some implementations, the acquisition function may be selected such that the acquisition function is used to select a next experiment, the results of which are likely to improve upon the current best process parameter values in terms of meeting the multiple target specifications. In some implementations, the acquisition function may be selected such that the acquisition function is used to select a next experiment, the results of which will further characterize process limitations and/or tradeoffs between various target specifications. In such implementations, the acquisition function may be used for target vector estimation. In such implementations, the acquisition function may be a Pareto Front based acquisition function. In some embodiments, the acquisition function identifies the second set of process parameter values based on both: (i) a set of points that represents differences between predicted wafer characteristics (e.g., using the second set of process parameter values applied to the one or more surrogate models); and (ii) the statistical uncertainty of the predictions made by the one or more models. Note that the set of points may be a set of non-dominated points where each point in the set of points is at least as good as the other points with respect to the multiple target wafer specifications, and better than at least one point with respect to at least one target wafer specification. In some embodiments, the set of points may be considered the Pareto Front. In some embodiments, the second set of process parameter values may be based on a hypervolume improvement of the predicted wafer characteristics over the current Pareto Front. For example, the second set of process parameter values may be selected by maximizing the hypervolume improvement.

In some implementations, the quality of the volume of available process space formed by the set of points (e.g., by the points associated with the Pareto Front) may be referred to as the hypervolume metric, H. In general, a larger volume (e.g., larger values of H) may correspond to a better solution set, e.g., comprised of process parameter values that yield wafer specifications closer to the desired multiple target specifications. Note that, when additional experiments are conducted by way of additional fabrication processes, observations from the additional experiments may be added to the historical data considered by the surrogate model. This may in turn add to the points which dominate over points in the current Pareto Front, thereby increasing the hypervolume H.

In some embodiments, the acquisition function may select the second set of process parameter values by considering an improvement in the hypervolume metric H of a volume formed by the set of points. The improvement in the hypervolume metric may be generally represented as HVL which is defined as HVI(y| [symbol] , r)=HV( [symbol] ∪y|r)−HV( [symbol] |r), where y∈ [symbol] ^{d} represents metrology of newly proposed experiments, [symbol] denotes the current Pareto Front, and r denotes a reference point in the metrology space. The reference point is usually chosen to be an existing process result that is dominated by other better process results. Therefore, HV( [symbol] |r) represents the hypervolume of available process space enclosed by the current Pareto Front, while HV( [symbol] ∪y|r) represents the improved hypervolume enclosed by the improved Pareto Front with new data y. An expected hypervolume improvement, represented as EHVI may be determined by:

$$EHVI ( y \vert 𝒫 , r ) = E [ HVI ( y \vert 𝒫 , r ) ] = {\int }_{{ℝ}^{d}} HVI ( y \vert 𝒫 , r ) \cdot p ( y ) dy$$

where p(y) is a posterior predictive distribution function.
In some implementations, the expected hypervolume improvement EHVI may be efficiently calculated by separating the non-dominated space into multiple integration slices. In some embodiments, the number of integration slices may be chosen so as to be as few as possible. The integral of criterion may be calculated within each integration slices. In some embodiments, the value of the integral of criterion may be the sum of its contribution to every integration slice. By way of example, the expected hypervolume improvement may be determined by:

$$EHVI ( y \vert 𝒫 , r ) = {\int }_{{y}_{1} = - ∞}^{∞} … {\int }_{{y}_{d} = - ∞}^{∞} {λ}_{d} [ {S}_{d} ∩ Δ ( \vec{y} ) ] \cdot p ( \vec{y} ) {dy}_{1} … {dy}_{d}$$

where S_{d} denotes the integration slices in a d-dimensional objective space, [symbol] ^{d}, i.e. the volume of the available objective space enclosed by the current Pareto Front [symbol] ; Δ(\vec{f}) denotes the improved objective space volume; λ_{d} denotes the Lebesgue measure on [symbol] ^{d}, i.e. the width of a slice of the available process space; p(\vec{y}) denotes the predictive posterior distribution. Since the acquisition function is defined for multi-objectives, the prediction posterior distribution is a multi-dimensional distribution function over all objectives, and integration is over the entire multi-dimensional objective space of the problem.

At 510, process 500 can perform the fabrication process using the second set of process parameters associated with the second experiment. Block 510 may be performed using techniques similar to those described above in connection with block 408 of FIG. 4.

At 512, process 500 can determine whether the multiple target specifications have been met. If, at 512, process 500 determines that the multiple target specifications have been met (“yes” at 512), process 500 can end. Conversely, if at 512, process 500 determines that the multiple target specifications have not been met (“no” at 512), process 500 can loop back to 506 and can update the statistical uncertainty based on experimental results (e.g., metrology results) associated with performance of the second experiment. It should be noted that, in some cases, the multiple target specifications may not all be met. In such instances, process 500 may be configured to loop through blocks 506-512 until a different stopping criterion has been reached. The different stopping criterion may include a predetermined number of iterations having been performed, an improvement in achieved wafer characteristics between two sequential experiments that is less than a predetermined improvement threshold, or the like.

### Context for Disclosed Computational Embodiments

Systems including fabrication tools as described herein may include logic for automated control of components.

The analysis logic may be designed and implemented in any of various ways. For example, the logic can be implemented in hardware and/or software. Examples are presented in the controller section herein. Hardware-implemented control logic may be provided in any of a variety of forms, including hard coded logic in digital signal processors, application-specific integrated circuits, and other devices that have algorithms implemented as hardware. Analysis logic may also be implemented as software or firmware instructions configured to be executed on a general-purpose processor. System control software may be provided by “programming” in a computer readable programming language.

The computer program code for controlling processes in a process sequence can be written in any conventional computer readable programming language: for example, assembly language, C, C++, Pascal, Fortran, or others. Compiled object code or script is executed by the processor to perform the tasks identified in the program. Also as indicated, the program code may be hard coded.

Integrated circuits used in logic may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated in the form of various individual settings (or program files), defining operational parameters for carrying out a particular analysis or image analysis application.

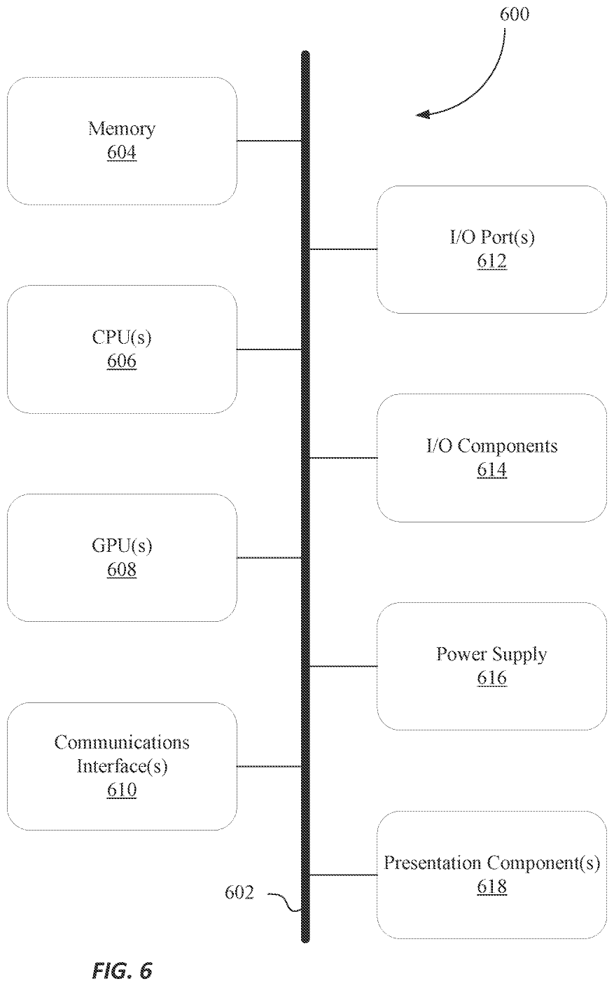

FIG. 6 is a block diagram of an example of the computing device 600 suitable for use in implementing some embodiments of the present disclosure. For example, device 600 may be suitable for implementing some or all functions for optimization of fabrication processes as described herein.

Computing device 600 may include a bus 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, and one or more presentation components 618 (e.g., display(s)). In addition to CPU 606 and GPU 608, computing device 600 may include additional logic devices that are not shown in FIG. 6, such as but not limited to an image signal processor (ISP), a digital signal processor (DSP), an ASIC, an FPGA, or the like.

Although the various blocks of FIG. 6 are shown as connected via the bus 602 with lines, this is not intended to be limiting and is for clarity only. For example, in some embodiments, a presentation component 618, such as a display device, may be considered an I/O component 614 (e.g., if the display is a touch screen). As another example, CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “electronic control unit (ECU),” “virtual reality system,” and/or other device or system types, as all are contemplated within the scope of the computing device of FIG. 6.

Bus 602 may represent one or more busses, such as an address bus, a data bus, a control bus, or a combination thereof. The bus 602 may include one or more bus types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus.

Memory 604 may include any of a variety of computer-readable media. The computer-readable media may be any available media that can be accessed by the computing device 600. The computer-readable media may include both volatile and nonvolatile media, and removable and non-removable media. By way of example, and not limitation, the computer-readable media may comprise computer-storage media and/or communication media.

The computer-storage media may include both volatile and nonvolatile media and/or removable and non-removable media implemented in any method or technology for storage of information such as computer-readable instructions, data structures, program modules, and/or other data types. For example, memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. As used herein, computer storage media does not comprise signals per se.

The communication media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the communication media may include wired media such as a wired network or direct-wired connection, and wireless media such as acoustic, RF, infrared and other wireless media. Combinations of any of the above should also be included within the scope of computer-readable media.

CPU(s) 606 may be configured to execute the computer-readable instructions to control one or more components of the computing device 600 to perform one or more of the methods and/or processes described herein. CPU(s) 606 may each include one or more cores (e.g., one, two, four, eight, twenty-eight, seventy-two, etc.) that are capable of handling a multitude of software threads simultaneously. CPU(s) 606 may include any type of processor and may include different types of processors depending on the type of computing device 600 implemented (e.g., processors with fewer cores for mobile devices and processors with more cores for servers). For example, depending on the type of computing device 600, the processor may be an ARM processor implemented using Reduced Instruction Set Computing (RISC) or an x86 processor implemented using Complex Instruction Set Computing (CISC). Computing device 600 may include one or more CPUs 606 in addition to one or more microprocessors or supplementary co-processors, such as math co-processors.

GPU(s) 608 may be used by computing device 600 to render graphics (e.g., 3D graphics). GPU(s) 608 may include many (e.g., tens, hundreds, or thousands) of cores that are capable of handling many software threads simultaneously. GPU(s) 608 may generate pixel data for output images in response to rendering commands (e.g., rendering commands from CPU(s) 606 received via a host interface). GPU(s) 608 may include graphics memory, such as display memory, for storing pixel data. The display memory may be included as part of memory 604. GPU(s) 608 may include two or more GPUs operating in parallel (e.g., via a link). When combined, each GPU 608 can generate pixel data for different portions of an output image or for different output images (e.g., a first GPU for a first image and a second GPU for a second image). Each GPU can include its own memory or can share memory with other GPUs.

In examples where the computing device 600 does not include the GPU(s) 608, the CPU(s) 606 may be used to render graphics.

Communication interface 610 may include one or more receivers, transmitters, and/or transceivers that enable computing device 600 to communicate with other computing devices via an electronic communication network, included wired and/or wireless communications. Communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet), low-power wide-area networks (e.g., LoRaWAN, SigFox, etc.), and/or the internet.

I/O ports 612 may enable the computing device 600 to be logically coupled to other devices including I/O components 614, presentation component(s) 618, and/or other components, some of which may be built in to (e.g., integrated in) computing device 600. Illustrative I/O components 614 include a microphone, mouse, keyboard, joystick, track pad, satellite dish, scanner, printer, wireless device, etc. I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of computing device 600. Computing device 600 may be include depth cameras, such as stereoscopic camera systems, infrared camera systems, RGB camera systems, touchscreen technology, and combinations of these, for gesture detection and recognition. Additionally, computing device 600 may include accelerometers or gyroscopes (e.g., as part of an inertia measurement unit (IMU)) that enable detection of motion. In some examples, the output of the accelerometers or gyroscopes may be used by computing device 600 to render immersive augmented reality or virtual reality.

Power supply 616 may include a hard-wired power supply, a battery power supply, or a combination thereof. Power supply 616 may provide power to computing device 600 to enable the components of computing device 600 to operate.

Presentation component(s) 618 may include a display (e.g., a monitor, a touch screen, a television screen, a heads-up-display (HUD), other display types, or a combination thereof), speakers, and/or other presentation components. Presentation component(s) 618 may receive data from other components (e.g., GPU(s) 608, CPU(s) 606, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

### Additional Considerations

As used in this specification and appended claims, the singular forms “a”, “an”, and “the” include plural referents unless the content and context dictates otherwise. For example, reference to “a cell” includes a combination of two or more such cells. Unless indicated otherwise, an “or” conjunction is used in its correct sense as a Boolean logical operator, encompassing both the selection of features in the alternative (A or B, where the selection of A is mutually exclusive from B) and the selection of features in conjunction (A or B, where both A and B are selected).

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items—it will be understood that a set or a subset can encompass only one member or multiple members (unless the context indicates otherwise).

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

Various computational elements including processors, memory, instructions, routines, models, or other components may be described or claimed as “configured to” perform a task or tasks. In such contexts, the phrase “configured to” is used to connote structure by indicating that the component includes structure (e.g., stored instructions, circuitry, etc.) that performs the task or tasks during operation. As such, the unit/circuit/component can be said to be configured to perform the task even when the specified component is not necessarily currently operational (e.g., is not on).

The components used with the “configured to” language may refer to hardware—for example, circuits, memory storing program instructions executable to implement the operation, etc. Additionally, “configured to” can refer to generic structure (e.g., generic circuitry) that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic. In some contexts, “configured to” may also include adapting a manufacturing process (e.g., a semiconductor fabrication facility) to fabricate devices (e.g., integrated circuits) that are adapted to implement or perform one or more tasks.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

1. A method of automatically optimizing fabrication processes, the method comprising:
(a) providing a first set of process parameter values associated with a first experiment to one or more models representing a fabrication process to obtain model results that associate a set of candidate process parameter values with corresponding wafer characteristic data, wherein the fabrication process is an etch process or a deposition process;
(b) characterizing a statistical uncertainty of predictions made by the one or more models representing the fabrication process using the obtained model results;
(c) using an acquisition function to select a second set of process parameter values associated with a second experiment, wherein the acquisition function identifies the second set of process parameters based on both: (i) a difference between predicted wafer characteristics associated with performance of the fabrication process using the second set of process parameter values and a target specification, wherein the predicted wafer characteristics are generated by the one or more models representing the fabrication process using the second set of process parameter values; and (ii) the statistical uncertainty of the predictions made by the one or more models;
(d) receiving results of the fabrication process performed using the second set of process parameter values associated with the second experiment; and
(e) determining whether the performance of the fabrication process using the second set of process parameter values generates a post-processed wafer having one or more wafer characteristics that meet the target specification based on the received results of the fabrication process.

2. The method of claim 1, further comprising:
(f) repeating (b)-(e) until a post-processed wafer that meets the target specification has been generated using the fabrication process.

3. The method of claim 1, wherein the target specification is a user-specified target specification.

4. The method of claim 1, wherein the acquisition function is a user-selected acquisition function.

5. The method of claim 4, wherein the acquisition function is configured to probabilistically quantify the improvement an arbitrary set of process parameter values would make in approaching the target specification compared to a baseline experiment.

6. The method of claim 1, further comprising receiving user-selected hyperparameters that specify a balance between exploration and exploitation utilized by the acquisition function to select the second set of process parameter values.

7. The method of claim 1, wherein the target specifications comprise a plurality of specifications to be achieved in a post-processed wafer that undergoes the fabrication process.

8. The method of claim 1, wherein the one or more models representing the fabrication process comprise at least one user-selected model.

9. The method of claim 1, wherein the one or more models representing the fabrication process comprise a physics-based model.

10. The method of claim 1, wherein the one or more models representing the fabrication process comprises one or more of: a neural network, a Gaussian Process model, decision tree model, regression model, or any combination thereof.

11. The method of claim 1, wherein characterizing the statistical uncertainty of the predictions made by the one or more models comprises determining a predictive posterior distribution that indicates a probability distribution of predicted wafer characteristics for a given set of process parameter values based on a set of measured data provided to the one or more models.

12. The method of claim 11, wherein, for an n-dimensional representation of process parameter space, a first region of the n-dimensional representation of the process parameter space is associated with greater statistical uncertainty than a second region of the n-dimensional representation of the process parameter space, and wherein the one or more models have received less experimental data obtained utilizing process parameter values associated with the first region.

13. The method of claim 12, wherein the second region of the n-dimensional representation of the process parameter space is associated with process parameter values that, when utilized by the fabrication process, generate post-processed wafers having wafer characteristics within a predetermined threshold of the target specification.

14. The method of claim 13, wherein the acquisition function is configured to determine whether to select the second set of process parameter values from either the first region or the second region.

15. The method of claim 12, wherein the n-dimensional representation of process parameter space is substantially unbounded for at least one dimension.

16. A method of automatically optimizing fabrication processes, the method comprising:
(a) receiving a plurality of target wafer specifications to be achieved by a fabrication process;
(b) providing a first set of process parameters associated with a first experiment to one or more models representing the fabrication process to obtain model results that associate a set of candidate process parameter values with corresponding wafer characteristics data;
(c) characterizing a statistical uncertainty of predictions made by the one or more models representing the fabrication process using the obtained model results; and
(d) using an acquisition function to select a second set of process parameter values associated with a second experiment, wherein the acquisition function identifies the second set of process parameter values based on: (i) a set of points that represents differences between a plurality of predicted wafer characteristics associated with performance of the fabrication process using the second set of process parameter values and the plurality of target wafer specifications; and (ii) the statistical uncertainty of the predictions made by the one or more models.

17. The method of claim 16, wherein the set of points improve on-wafer performance with respect to the plurality of target wafer specifications.

18. The method of claim 16, wherein the set of points comprise a Pareto Front.

19. The method of claim 18, wherein the acquisition function determines an expected improvement in a hypervolume formed by the Pareto Front using the plurality of predicted wafer characteristics associated with the performance of the fabrication process using the second set of process parameter values.

20. The method of claim 16, wherein at least two process parameter values in the second set of process parameter values different from the corresponding process parameter values in the first set of process parameter values.

21. The method of claim 16, further comprising determining, based at least in part on the set of points, that at least one target wafer specification of the plurality of target wafer specifications cannot be met by the fabrication process.

22. The method of claim 21, further comprising identifying a second plurality of predicted wafer characteristics within a predetermined error threshold of the plurality of target wafer specifications, wherein the second plurality of predicted wafer characteristics is associated with performance of the fabrication process using a third set of process parameter values.

23. A computer program product comprising a non-transitory computer readable medium on which is provided computer executable instructions for causing a computational system to perform a method of automatically optimizing fabrication processes, the method comprising:
(a) providing a first set of process parameter values associated with a first experiment to one or more models representing a fabrication process to obtain model results that associate a set of candidate process parameter values with corresponding wafer characteristic data, wherein the fabrication process is an etch process or a deposition process;
(b) characterizing a statistical uncertainty of predictions made by the one or more models representing the fabrication process using the obtained model results;
(c) using an acquisition function to select a second set of process parameter values associated with a second experiment, wherein the acquisition function identifies the second set of process parameters based on both: (i) a difference between predicted wafer characteristics associated with performance of the fabrication process using the second set of process parameter values and a target specification, wherein the predicted wafer characteristics are generated by the one or more models representing the fabrication process using the second set of process parameter values; and (ii) the statistical uncertainty of the predictions made by the one or more models;
(d) receiving results of the fabrication process performed using the second set of process parameter values associated with the second experiment; and
(e) determining whether the performance of the fabrication process using the second set of process parameter values generates a post-processed wafer having one or more wafer characteristics that meet the target specification based on the received results of the fabrication process.

24. The computer program product of claim 23, wherein the method further comprises:
(f) repeating (b)-(e) until a post-processed wafer that meets the target specification has been generated using the fabrication process.

25. The computer program product of claim 23, wherein the target specification is a user-specified target specification.

26. The computer program product of claim 23, wherein the acquisition function is a user-selected acquisition function.

27. (canceled)

28. The computer program product of claim 23, wherein the method further comprises receiving user-selected hyperparameters that specify a balance between exploration and exploitation utilized by the acquisition function to select the second set of process parameter values.

29. The computer program product of claim 23, wherein the target specifications comprise a plurality of specifications to be achieved in a post-processed wafer that undergoes the fabrication process.

30. The computer program product of claim 23, wherein the one or more models representing the fabrication process comprise at least one user-selected model.

31. (canceled)

32. (canceled)

33. (canceled)

34. (canceled)

35. (canceled)

36. (canceled)

37. (canceled)

38. A computer program product comprising a non-transitory computer readable medium on which is provided computer executable instructions for causing a computational system to perform a method of automatically optimizing fabrication processes, the method comprising:
(a) receiving a plurality of target wafer specifications to be achieved by a fabrication process;
(b) providing a first set of process parameters associated with a first experiment to one or more models representing the fabrication process to obtain model results that associate a set of candidate process parameter values with corresponding wafer characteristics data;
(c) characterizing a statistical uncertainty of predictions made by the one or more models representing the fabrication process using the obtained model results; and
(d) using an acquisition function to select a second set of process parameter values associated with a second experiment, wherein the acquisition function identifies the second set of process parameter values based on: (i) a set of points that represents differences between a plurality of predicted wafer characteristics associated with performance of the fabrication process using the second set of process parameter values and the plurality of target wafer specifications; and (ii) the statistical uncertainty of the predictions made by the one or more models.

39.-66. (canceled)
